(19) United States
(12) Patent Application Publication
(10) Pub. No.: US 2026/0059055 A1
(43) Pub. Date: Feb. 26, 2026

(54) INFORMATION PROCESSING APPARATUS, INFORMATION PROCESSING METHOD, AND NON-TRANSITORY RECORDING MEDIUM

(71) Applicant: PFU Limited, ISHIKAWA (JP)

(72) Inventors: Naoki KISHIKAWA, ISHIKAWA (JP); Tomoaki WADA, ISHIKAWA (JP)

(21) Appl. No.: 19/285,331

(22) Filed: Jul. 30, 2025

(30) Foreign Application Priority Data
Aug. 22, 2024 (JP) 2024-140793

(51) Int. Cl. H04N 1/00

(52) U.S. Cl. CPC H04N 1/00079; H04N 1/00013; H04N 1/00037; H04N 1/0009; H04N 1/00413; H04N 2201/0081

(57) ABSTRACT

An information processing apparatus includes circuitry to acquire setting information related to use of an electronic apparatus, determine whether the setting information is available, and display, on a display, the setting information according to a determination result indicating whether the setting information is available.

### CROSS-REFERENCE TO RELATED APPLICATIONS

This patent application is based on and claims priority pursuant to 35 U.S.C. § 119(a) to Japanese Patent Application No. 2024-140793, filed on Aug. 22, 2024, in the Japan Patent Office, the entire disclosure of which is hereby incorporated by reference herein.

### BACKGROUND

The present disclosure relates to an information processing apparatus, an information processing method, and a non-transitory recording medium.

A technique for synchronizing setting information related to the use of an electronic apparatus is known. For example, an image forming apparatus known in the art uploads an application and a backup file including a setting file for the application to an external apparatus, and when restoring the backup file uploaded to the external apparatus, skips the restoration of the setting file corresponding to filtering information included in the backup file and restores the backup file.

### SUMMARY

The information processing apparatus according to one aspect of the present disclosure includes circuitry to acquire setting information related to use of an electronic apparatus, determine whether the setting information is available, and display, on a display, the setting information according to a determination result indicating whether the setting information is available.

The information processing method performed by an information processing apparatus, according to another aspect of the present disclosure includes acquiring setting information related to use of an electronic apparatus, determining whether the setting information is available, and displaying, on a display, the setting information according to a determination result of the determining.

The computer-readable, non-transitory medium according to one aspect of the present disclosure stores a computer program. The computer program causes an information processing apparatus including circuitry to execute a process. The process includes acquiring setting information related to use of an electronic apparatus, determining whether the setting information is available, and displaying, on a display, the setting information according to a determination result of the determining.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of the overall configuration of a profile synchronization system;

FIG. 2 is a block diagram illustrating an example of a hardware configuration of a computer;

FIG. 3 is a block diagram illustrating an example of a functional configuration of the profile synchronization system of FIG. 1;

FIG. 4 is a diagram illustrating an example of a profile;

FIG. 5 is a diagram illustrating an example of a mapping table;

FIG. 6 is a sequence diagram illustrating an example of a profile synchronization process;

FIG. 7 is a flowchart of an example of a determination process;

FIG. 8 is a diagram illustrating a first example of a profile selection screen;

FIG. 9 is a diagram illustrating a second example of a profile selection screen;

FIG. 10 is a diagram illustrating a third example of a profile selection screen;

FIG. 11 is a diagram illustrating a first example of a profile creation screen; and

FIG. 12 is a diagram illustrating a second example of a profile creation screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected, and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described below. In this specification and drawings, elements having substantially the same functional configurations are denoted by identical or similar reference signs, and redundant descriptions thereof are omitted.

### Embodiment

An embodiment of the present disclosure is an example of an information processing system that synchronizes a profile among multiple information processing apparatuses. In the following description, the information processing system according to the present embodiment is referred to as a “profile synchronization system.”

The profile is electronic data indicating setting information related to the use of an electronic apparatus. The electronic apparatus includes office equipment, home appliances, and facility equipment. The electronic apparatus may be, for example, an image reading apparatus such as a scanner. The electronic apparatus is not limited to an image reading apparatus. Examples thereof include a printer, a facsimile machine, and a digital multifunctional peripheral (MFP). The digital MFP is also referred to as digital multifunctional product or printer.

An application for using a scanner from an information processing terminal such as a personal computer or a smartphone is used. The application for using the scanner is referred to as “scanner software.” A user of the scanner can create a profile related to the use of the scanner by operating the scanner software and use the profile.

Some scanner software has a function of synchronizing a profile created by a specific user with multiple information processing terminals. The function of synchronizing a profile allows the user to use the same profile on a different information processing terminal, thereby enhancing user convenience.

The profile related to the use of a scanner may include path information indicating the location of a file or a folder. Examples of the path information included in the profile include a storage destination setting for specifying a folder in which an image file generated by scanning is stored and an integration setting for specifying an execution file for an application that processes the image file. When the profile includes the path information, a profile created by an information processing terminal may not be used by another information processing terminal. For example, when one information processing terminal has a directory structure different from that of another, a folder or path present on the one information processing terminal may not exist on the other one.

Specifically, for example, when an operating system (OS) installed on one information processing terminal differs from that on another, the directory structures of the terminals may be different as well. Further, for example, even when identical OSs are installed on multiple information processing terminals, the directory structure (such as the desktop) associated with a user account may vary depending on the user account used to log in.

However, users of the profile synchronization function expect consistent usability across different information processing terminals. When a profile is not synchronized or unavailable even after being synchronized, the user manually creates a profile corresponding to an information processing terminal again. The unavailability of a profile after synchronization fails to meet user expectations and leads to a decline in user convenience.

An object of the present embodiment is to enhance the usability of the setting information. In the present embodiment, whether setting information related to the use of an electronic apparatus is available is determined, and the setting information is displayed according to the determination result. According to an aspect of the present embodiment, the availability of the displayed setting information can be easily recognized by the user, enhancing the usability of the setting information.

### Overall Configuration

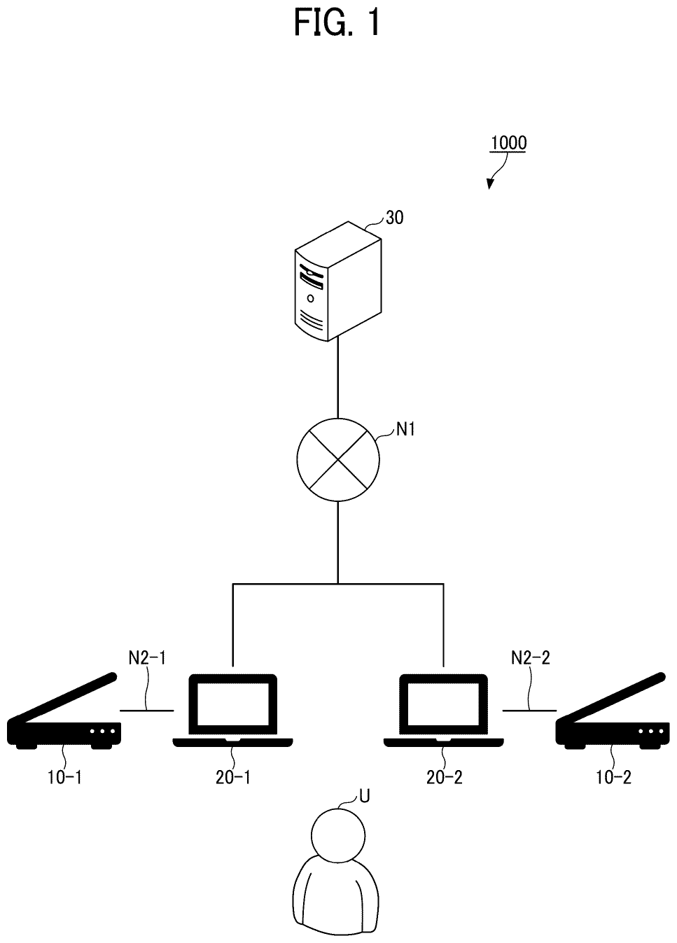

An overall configuration of a profile synchronization system is described with reference to FIG. 1. FIG. 1 is a diagram illustrating an example of the overall configuration of a profile synchronization system.

As illustrated in FIG. 1, the profile synchronization system 1000 includes multiple scanners 10-1 and 10-2, multiple user terminals 20-1 and 20-2, and a synchronization server 30. In the following description, when there is no need to distinguish between the multiple scanners 10-1 and 10-2, the multiple scanners 10-1 and 10-2 may be collectively or individually referred to as scanner 10. The same applies to the multiple user terminals 20-1 and 20-2. The scanner 10 is an example of an electronic apparatus. The user terminal 20 is an example of an information processing apparatus.

In the following description, when there are multiple scanners 10, reference signs with suffixes are used for distinction, like “scanner 10-1” and “scanner 10-2.” When the term “scanner 10” without a suffix is used, the description thereof applies to all the scanners 10. The same applies to the user terminal 20.

The user terminal 20 and the synchronization server 30 are connected to each other via a communication network N1 for communication. The communication network N1 may be, for example, a local area network (LAN), a virtual private network (VPN), or the Internet.

The scanner 10 and the user terminal 20 are connected to each other via a communication path N2 for communication. The communication path N2 may be a wired or wireless communication network, or may be serial communication by using a cable such as a universal serial bus (USB) cable. The communication path N2 may be part of a communication network N1.

The scanner 10 is an example of an image reading apparatus that optically reads an image formed on an image forming medium. The scanner 10 may output image data read from an image forming medium. The scanner 10 may perform data processing such as optical character recognition (OCR) on the image data read from the image forming medium and output the processing result. The scanner 10 may transmit the image data or the processing result of the image data to the user terminal 20 via the communication path N2.

The user terminal 20 is an example of an information processing apparatus such as a personal computer, a smartphone, or a tablet terminal that is operated by a user U of the scanner 10. Scanner software is installed on the user terminal 20. The user U can create, use, and synchronize profiles through the operation of the scanner software.

In the present embodiment, the user U uses the two scanners 10-1 and 10-2 by operating the two user terminals 20-1 and 20-2, respectively. The scanner 10-1 and the user terminal 20-1 may be installed in a space different from a space where the scanner 10-2 and the user terminal 20-2 are located. For example, the scanner 10-1 and the user terminal 20-1 may be installed at the workplace of the user U, and the scanner 10-2 and the user terminal 20-2 may be installed in the home of the user U.

The profile synchronization system 1000 synchronizes profiles created by the user U between the scanner software installed on the user terminal 20-1 and the scanner software installed on the user terminal 20-2. Accordingly, the user U can use a profile created by the user terminal 20-1 on the user terminal 20-2. Similarly, the user U can use a profile created by the user terminal 20-2 on the user terminal 20-1.

The synchronization server 30 is an example of an information processing apparatus such as a server, a workstation, or a personal computer that controls a profile synchronization function. The synchronization server 30 receives a profile from the user terminal 20 and stores the profile in a memory. The synchronization server 30 transmits the profile read from the memory to the user terminal 20 in response to a request from the user terminal 20.

The overall configuration of the profile synchronization system 1000 illustrated in FIG. 1 is an example, and the system configuration may vary depending on the application or purpose. For example, the profile synchronization system 1000 may include three or more scanners 10 or three or more user terminals 20. For example, the synchronization server 30 may be implemented by multiple computers or may be implemented as a cloud computing service. The device classification such as the scanner 10, the user terminal 20, and the synchronization server 30 illustrated in FIG. 1 is an example.

For example, the profile synchronization system 1000 may directly synchronize the profiles between the user terminal 20-1 and the user terminal 20-2 without the synchronization server 30. In this case, the profile synchronization system 1000 may not include the synchronization server 30. Further, for example, the profile synchronization system 1000 may synchronize the profiles between the scanner 10-1 and the scanner 10-2 via or not via the synchronization server 30.

### Hardware Configuration

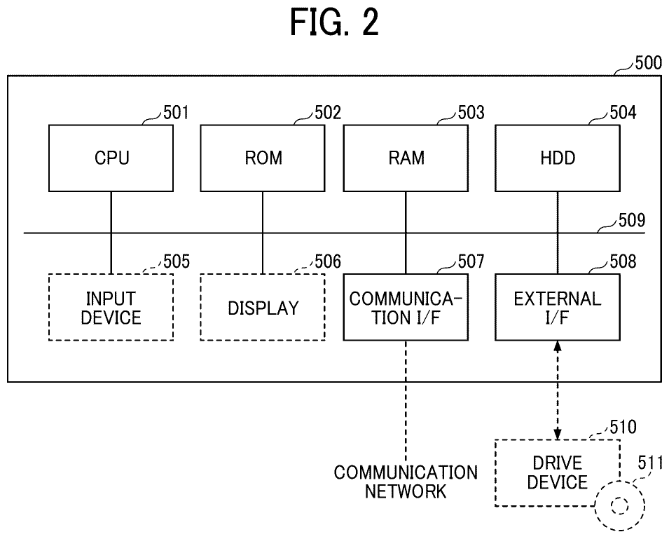

The hardware configuration of the profile synchronization system 1000 is described below with reference to FIG. 2. The user terminal 20 and the synchronization server 30 may be implemented by, for example, a computer. FIG. 2 is a block diagram illustrating an example of a hardware configuration of a computer.

As illustrated in FIG. 2, a computer 500 includes a central processing unit (CPU) 501, a read-only memory (ROM) 502, a random-access memory (RAM) 503, a hard disk drive (HDD) 504, an input device 505, a display 506, a communication interface (I/F) 507, and an external I/F 508. The CPU 501, the ROM 502, and the RAM 503 form a so-called computer. The hardware components of the computer 500 are connected to each other via a bus line 509. The input device 505 and the display 506 may be connected via the external I/F 508 rather than directly to the bus line 509, and this may also be used as a form of use.

The CPU 501 reads programs or data from a memory such as the ROM 502 or the HDD 504 into the RAM 503 and executes processing for controlling the computer 500 or implementing a function of the computer 500. The computer 500 may include a graphics processing unit (GPU) in addition to the CPU 501 or instead of the CPU 501.

The ROM 502 is an example of a nonvolatile semiconductor memory (storage device) that retains programs or data even after the power is turned off. The ROM 502 functions as a main memory that stores various programs and data used by the CPU 501 to execute various programs installed on the HDD 504. Specifically, the ROM 502 stores boot programs such as a basic input output system (BIOS) and an external executable firmware interface (EFI) executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random-access memory (DRAM) or a static random-access memory (SRAM). The RAM 503 provides a work area for loading various programs installed on the HDD 504 when the programs are executed by the CPU 501.

The HDD 504 is an example of a nonvolatile memory that stores programs or data. The programs or data stored in the HDD 504 include an OS that is basic software for controlling the computer 500 and applications that provide various functions on the OS. The computer 500 may use a memory (for example, a solid-state drive (SSD)) using a flash memory as a storage medium instead of the HDD 504.

The input device 505 is used by a user to input various signals. The input device 505 includes a touch panel, operation keys or buttons, a keyboard, a mouse, and a microphone for inputting sound data such as voice.

The display 506 includes a display such as a liquid crystal display or an organic electro-luminescence (EL) display that displays a screen, and a speaker that outputs sound data such as voice.

The communication I/F 507 is an interface for connecting to a communication network that allows the computer 500 to perform data communication.

The external I/F 508 is an interface that connects the computer 500 to an external device. The external device includes a drive device 510.

The drive device 510 is a device for setting a recording medium 511. Examples of the recording medium 511 include a compact disc-read-only memory (CD-ROM), a flexible disk, and a magneto-optical disc that records data optically, electrically, or magnetically. Other examples of the recording medium 511 include a semiconductor memory such as a ROM or a flash memory that electrically records data. The external I/F 508 allows the computer 500 to read or write data from or to the recording medium 511.

For example, the various programs are installed on the HDD 504 by placing the distributed recording medium 511 into the drive device 510 connected to the external I/F 508 and reading the various programs recorded on the recording medium 511 by the drive device 510. Alternatively, the various programs that are installed in the HDD 504 may be installed by being downloaded from another network different from the communication network N1 via the communication I/F 507.

### Functional Configuration

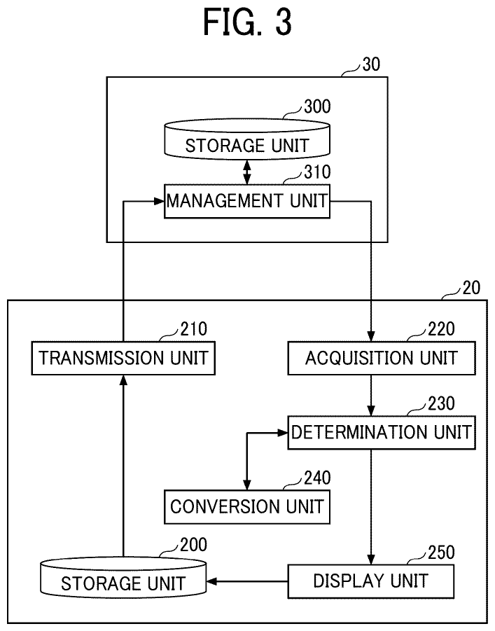

The functional configuration of the profile synchronization system 1000 is described below with reference to FIG. 3. FIG. 3 is a block diagram illustrating an example of a functional configuration of the profile synchronization system 1000.

### Synchronization Server

As illustrated in FIG. 3, the synchronization server 30 includes a storage unit 300 and a management unit 310. The functions of the storage unit 300 and the management unit 310 are implemented by executing a server program that has been installed on the synchronization server 30 in advance.

For example, the storage unit 300 is implemented by the HDD 504 illustrated in FIG. 2. For example, the management unit 310 is implemented by processing that is executed by the CPU 501 according to a program loaded from the HDD 504 illustrated in FIG. 2 into the RAM 503 illustrated in FIG. 2.

The storage unit 300 stores a profile. The profiles stored in the storage unit 300 are managed by the management unit 310. The profile management may include addition, updating, synchronization, and deletion of profiles.

A profile stored in the storage unit 300 may be associated with information indicating an environment in which the profile is created (in the following description, referred to as “creation environment information”). The creation environment information may include information indicating an individual or a type of the scanner 10, information indicating an individual or a type of the user terminal 20, information indicating a user account, information regarding assignment of a special path, and information indicating a drive letter of an OS.

The storage unit 300 may store a mapping table. The mapping table is tabular data for converting path information including an abstract representation into path information corresponding to the directory structure of the user terminal 20. The abstract representation is information that represents a path independently of any directory structure. The abstract representation may be any pre-set character string set.

The management unit 310 manages a profile. The management unit 310 may manage a profile stored in the storage unit 300. The management unit 310 may receive a profile created by the user terminal 20 and store the profile in the storage unit 300. The management unit 310 may receive a profile edited by the user terminal 20 and update the profile stored in the storage unit 300. The management unit 310 may delete a profile stored in the storage unit 300 in response to a request from the user terminal 20.

The management unit 310 may transmit a profile stored in the storage unit 300 to the user terminal 20 in response to a request from the user terminal 20. The management unit 310 may receive a profile from the user terminal 20 and transmit only a difference between the received profile and the profile stored in the storage unit 300 to the user terminal 20. When transmitting the profile or the difference between the profiles, the management unit 310 may transmit the mapping table stored in the storage unit 300 to the user terminal 20.

### Profile

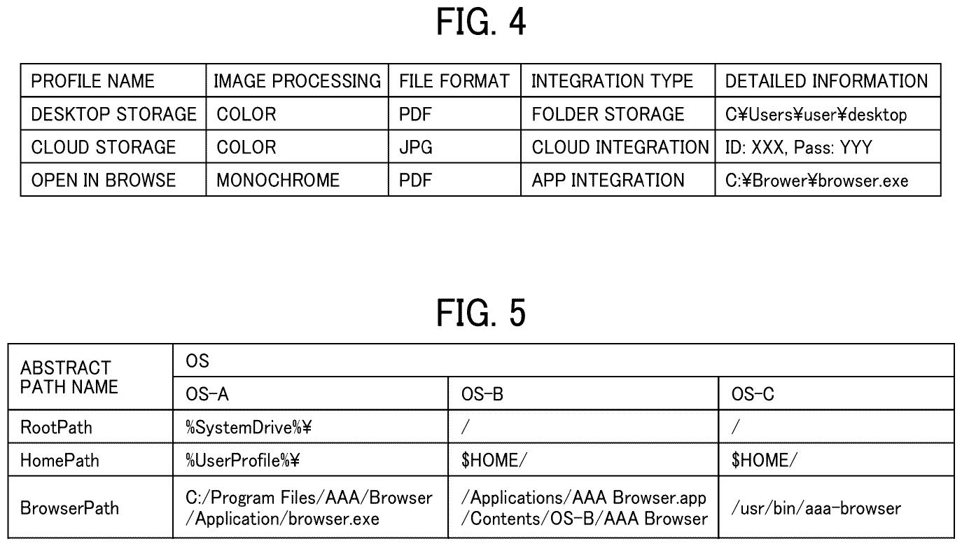

The profiles stored in the storage unit 300 are described below in detail with reference to FIG. 4. FIG. 4 is a diagram illustrating an example of a profile.

As illustrated in FIG. 4, a profile includes data items such as a profile name, image processing, file format, integration type, and detailed information. The profile name is an example of identification information for identifying a profile. The image processing is information indicating a method of processing an image generated by scanning. The file format is a file format for storing an image generated by scanning. The integration type is information indicating the type of processing applied to an image generated by scanning. The detailed information is information indicating, for example, parameters related to processing.

The profile may include path information according to the integration type. The profiles illustrated in FIG. 4 indicate that, when the integration type is “SAVE TO FOLDER,” the detailed information includes path information indicating a folder of a storage destination. The profiles illustrated in FIG. 4 indicate that, when the integration type is “application integration,” the detailed information includes path information indicating an execution file.

Mapping Table: A mapping table stored in the storage unit 300 is described below in detail with reference to FIG. 5. FIG. 5 is a diagram illustrating an example of a mapping table.

As illustrated in FIG. 5, the mapping table is tabular data in which an abstract path name that is an example of an abstract representation, and a path corresponding to a directory structure for each OS are associated with each other. The path corresponding to the directory structure may be described using an environment variable set to the OS by default. The mapping table of FIG. 5 indicates that the path includes an environment variable (%SystemDrive%, $HOME, etc.).

The mapping table may be included in the scanner software and installed on the user terminal 20 together with the scanner software. The mapping table may be directly coded into the scanner software. In this case, the storage unit 300 may not store the mapping table.

### User Terminal

As illustrated in FIG. 3, the user terminal 20 includes a storage unit 200, a transmission unit 210, an acquisition unit 220, a determination unit 230, a conversion unit 240, and a display unit 250. The functions of the storage unit 200, the transmission unit 210, the acquisition unit 220, the determination unit 230, the conversion unit 240, and the display unit 250 are implemented by executing scanner software that has been installed on the user terminal 20 in advance.

For example, the storage unit 200 is implemented by the HDD 504 illustrated in FIG. 2. For example, the transmission unit 210, the acquisition unit 220, the determination unit 230, the conversion unit 240, and the display unit 250 are implemented by processing that is executed by the CPU 501 according to a program that is loaded from the HDD 504 of illustrated in FIG. 2 into the RAM 503 illustrated in FIG. 2.

The storage unit 200 stores a profile. The profile stored in the storage unit 200 may be created by the user U operating the scanner software installed on the user terminal 20. The profile stored in the storage unit 200 may be acquired by the acquisition unit 220 from the synchronization server 30.

The transmission unit 210 transmits the profile stored in the storage unit 200 to the synchronization server 30. The transmission unit 210 may transmit the profile to the synchronization server 30 at any timing. For example, the transmission unit 210 may transmit the profile to the synchronization server 30 in response to an operation performed by the user U on the scanner software. The transmission unit 210 may detect that a new profile is stored in the storage unit 200 or that the profile stored in the storage unit 200 is updated, and transmit the added or updated profile to the synchronization server 30.

The acquisition unit 220 acquires a profile from the synchronization server 30. The acquisition unit 220 may request the synchronization server 30 to transmit a profile and receive the profile transmitted by the synchronization server 30 in response to the request. The acquisition unit 220 may read a profile stored in the storage unit 300 of the synchronization server 30.

The acquisition unit 220 may acquire the mapping table from the synchronization server 30. The acquisition unit 220 may receive the mapping table transmitted by the synchronization server 30 together with the profile. The acquisition unit 220 may read the mapping table stored in the storage unit 300 of the synchronization server 30.

The determination unit 230 determines whether the profile acquired by the acquisition unit 220 is available or unavailable. When the creation environment of the profile is identical to the environment of the user terminal 20, the determination unit 230 may determine that the profile is available. The determination unit 230 may determine whether the environments are identical based on the creation environment information associated with the profile.

When the profile is unavailable on the scanner 10, the determination unit 230 may determine that the profile is unavailable. For example, when a setting related to scanning included in the profile is not supported by the scanner 10, the determination unit 230 may determine that the profile is unavailable on the scanner 10. The settings related to scanning may include a reading side (double-sided or single-sided), a resolution (dpi), and a file format. For example, when the reading side set in a profile is the double-sided scan and the scanner 10 is a model that supports only the single-sided scan, the determination unit 230 may determine that the profile is unavailable on the scanner 10. For example, when the resolution is set to 1200 dpi in a profile and the scanner 10 is a model that supports up to 600 dpi, the determination unit 230 may determine that the profile is unavailable in the scanner 10.

When a setting related to scanning is not supported by the scanner 10, the determination unit 230 may adjust the setting related to scanning to be available on the scanner 10. For example, when the reading side set in a profile is the double-sided scan and the scanner 10 is a model that supports only the single-sided scan, the determination unit 230 may adjust the reading side set in the profile to the single-sided scan. For example, when the resolution is set to 1200 dpi in a profile and the scanner 10 is a model that supports up to 600 dpi, the determination unit 230 may adjust the resolution set in the profile to 600 dpi.

When a profile includes path information indicating a file or a folder that is absent in the user terminal 20, the determination unit 230 may determine that the profile is unavailable. When a profile includes path information including an abstract representation, the determination unit 230 may convert the path information by the conversion unit 240. Then, when the converted path information indicates a file or a folder that is absent in the user terminal 20, the determination unit 230 may determine that the profile is unavailable.

The conversion unit 240 converts path information included in a profile acquired by the acquisition unit 220 to obtain converted path information. When the profile includes path information including an abstract representation, the conversion unit 240 may convert the path information into path information corresponding to the directory structure of the user terminal 20. The conversion unit 240 may convert the path information included in the profile by using a mapping table to obtain converted path information. The conversion unit 240 may use the mapping table acquired by the acquisition unit 220 or may use the mapping table installed together with the scanner software.

When converting the path information, the conversion unit 240 may store conversion history including the path information before the conversion and the path information after the conversion in the storage unit 200. When conversion history is stored in the storage unit 200, the conversion unit 240 may convert the path information included in the profile based on the conversion history.

The display unit 250 displays a profile acquired by the acquisition unit 220. The display unit 250 may display the profile on a screen of the scanner software. The display unit 250 may display the profile according to a determination result by the determination unit 230. In other words, the display unit 250 may display the profile in a state according to whether the profile is available.

For example, the display unit 250 may display a profile determined to be available and may hide a profile determined to be unavailable, namely, the display unit 250 may display the profile when the determination result indicates that the profile is available and may hide the profile when the determination result indicates that the profile is unavailable. For example, the display unit 250 may display a profile determined to be available as enabled (in an enabled state), and display a profile determined to be unavailable as disabled (in a disabled state). Enabled display refers to content being displayed on the screen in an operable state, and disabled display refers to content being displayed on the screen in an inoperable state.

For example, the display unit 250 may display information indicating a reason for the determination of unavailability in association with the profile determined to be unavailable. For example, the display unit 250 may display a profile determined to be unavailable in a disabled state, and display text indicating a reason for the determination of unavailability with a tool tip when a cursor moves close to the profile. Examples of the reasons for the determination of unavailability include the absence of a storage destination path, the lack of an execution file for the integration application, and the scanner not supporting the settings.

The functional configuration of the profile synchronization system 1000 illustrated in FIG. 3 is one example. Needless to say, the functional configuration may vary depending on the application or purpose. The manner of dividing the processing units, such as the storage unit 200, the transmission unit 210, the acquisition unit 220, the determination unit 230, the conversion unit 240, the display unit 250, the storage unit 300, and the management unit 310 illustrated in FIG. 3, is an example.

### Profile Synchronization Method

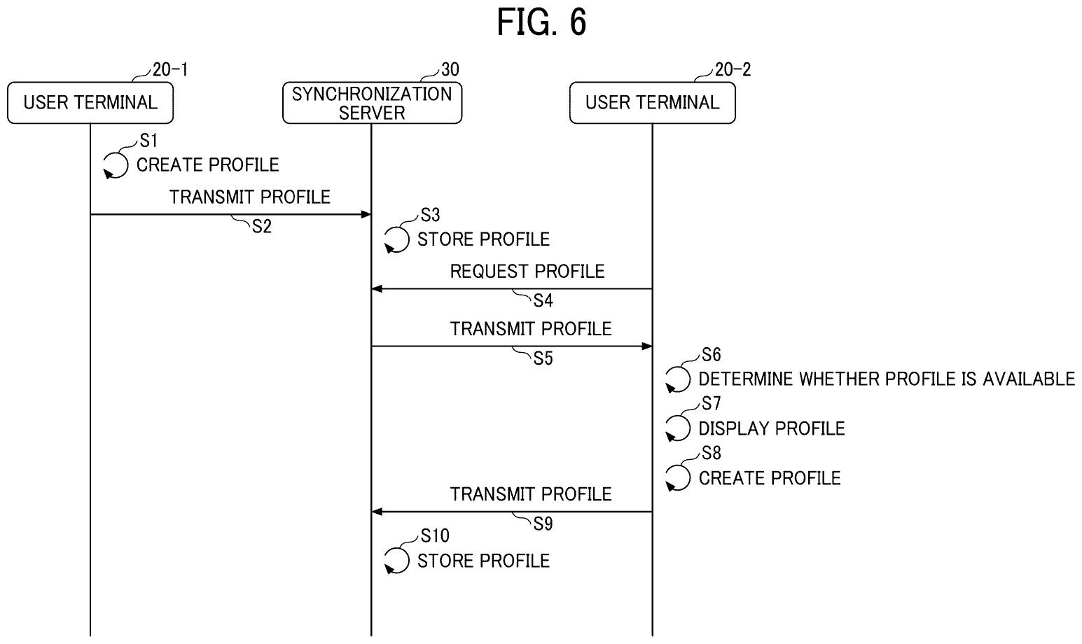

A profile synchronization method executed by the profile synchronization system 1000 is described below with reference to FIG. 6. FIG. 6 is a sequence diagram illustrating an example of a profile synchronization method.

In Step S1, the scanner software is launched on the user terminal 20-1 in response to an operation performed by the user U. The display unit 250 of the user terminal 20-1 displays a screen of the scanner software on the display 506. The user U creates a profile by operating the scanner software displayed on the display 506. The user U may set path information to be included in the profile by using an abstract representation. The display unit 250 may convert path information input by the user U into path information using an abstract representation. The display unit 250 stores the created profile in the storage unit 200.

In Step S2, the transmission unit 210 of the user terminal 20-1 transmits a profile addition request for adding a profile to the synchronization server 30. The profile addition request includes the profile stored in the storage unit 200 and creation environment information related to the profile.

In Step S3, the management unit 310 of the synchronization server 30 receives the profile addition request from the user terminal 20-1. The management unit 310 stores the profile and the creation environment information included in the profile addition request in the storage unit 300 in association with each other.

In Step S4, the scanner software is launched on the user terminal 20-2 in response to an operation performed by the user U. When the scanner software starts launching, the acquisition unit 220 of the user terminal 20-2 transmits a profile acquisition request for acquiring a profile to the synchronization server 30. The profile acquisition request may include a profile stored in the storage unit 200.

In Step S5, the management unit 310 of the synchronization server 30 receives the profile acquisition request from the user terminal 20-2. The management unit 310 reads the profile, the creation environment information, and the mapping table stored in the storage unit 300. When a profile is included in the profile acquisition request, the management unit 310 may compare the profile included in the profile acquisition request with the profile read from the storage unit 300 and extract a difference between the profiles. The management unit 310 transmits the profile (or the difference between the profiles), the creation environment information, and the mapping table to the user terminal 20-2.

In Step S6, the acquisition unit 220 of the user terminal 20-2 receives the profile (or the difference between the profiles), the creation environmental information, and the mapping table from the synchronization server 30. The acquisition unit 220 sends the profile (or the difference between the profiles) and the creation environment information to the determination unit 230. The acquisition unit 220 sends the mapping table to the conversion unit 240.

The determination unit 230 receives the profile (or the difference between the profiles) and the creation environment information from the acquisition unit 220. When the difference between the profiles is received, the determination unit 230 reads the profile from the storage unit 200 and updates the profile read from the storage unit 200 based on the difference between the profiles. The determination unit 230 determines whether the profile received from the synchronization server 30 or the updated profile is available. The determination unit 230 sends the profile and the determination result to the display unit 250.

In Step S7, the display unit 250 of the user terminal 20-2 receives the profile and the determination result from the determination unit 230. The display unit 250 displays a screen of the scanner software on the display 506. At this time, the display unit 250 displays the profile on the screen of the scanner software in a state corresponding to the determination result. For example, the display unit 250 may display a profile determined to be available and may hide a profile determined to be unavailable, namely, the display unit 250 may display the profile when the determination result indicates that the profile is available and may hide the profile when the determination result indicates that the profile is unavailable. For example, the display unit 250 may display a profile determined to be available as enabled (in an enabled state), and display a profile determined to be unavailable as disabled (in a disabled state).

In Step S8, a profile is created by the user U operating the scanner software. The user U may create a new profile. The user U may create a new profile by referring to an existing profile. When a new profile is created by referring to an existing profile, a profile determined to be unavailable may be referred to. In this case, even a profile that is not displayed by the scanner software may be referred to.

When a profile is newly created, the scanner software displays all setting items as blank or default values. When creating a profile by referring to an existing profile, the scanner software may display setting items set in the existing profile as defaults, and display setting items not set in the existing profile as blanks or default values. When a profile is created with reference to a profile determined to be unavailable, information indicating the reason for the determination of unavailability may be displayed in association with the setting information that has been determined to be unavailable.

The user U inputs values to setting items in the scanner software to create a profile and performs an operation for storing the created profile. The display unit 250 stores the created profile in the storage unit 200 in response to the operation for storing the profile.

In Step S9, the transmission unit 210 of the user terminal 20-2 transmits a profile addition request for adding a profile to the synchronization server 30. The profile addition request includes the profile created in Step S8 and creation environmental information related to the profile.

In Step S10, the management unit 310 of the synchronization server 30 receives the profile addition request from the user terminal 20-2. The management unit 310 stores the profile and the creation environment information included in the profile addition request in the storage unit 300 in association with each other.

### Determination Process

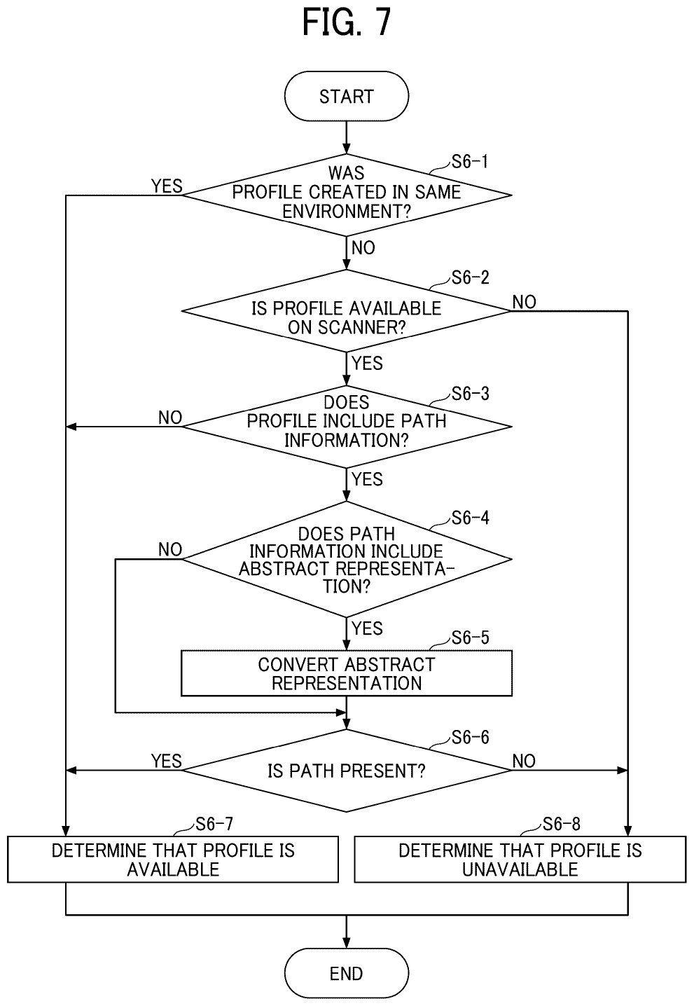

The determination process (Step S6 in FIG. 6) performed by the user terminal 20-2 is described below in detail with reference to FIG. 7. FIG. 7 is a flowchart of an example of the determination process.

In Step S6-1, the determination unit 230 of the user terminal 20-2 determines whether the creation environment of the profile is identical to the environment of the user terminal 20-2, namely, whether the profile was created in the same environment as the user terminal 20-2, based on the creation environmental information. Specifically, the determination unit 230 determines whether the information items indicating the scanner, the user terminal, the user account, the assignment of the special path, the drive letter, etc., indicated in the creation environment information are identical to those of the scanner 10-2 or the user terminal 20-2.

When the creation environment of the profile is determined to be identical to the environment of the user terminal 20-2 (YES), the determination unit 230 advances the process to Step S6-7. On the other hand, when the creation environment of the profile is determined not to be identical to the environment of the user terminal 20-2 (NO), the determination unit 230 advances the process to Step S6-2.

In Step S6-2, the determination unit 230 of the user terminal 20-2 determines whether the profile is available on the scanner 10-2. Specifically, the determination unit 230 determines whether the settings related to scanning included in the profile are supported by the scanner 10-2.

When the profile is determined to be available on the scanner 10-2 (YES), the determination unit 230 advances the process to Step S6-3. On the other hand, when the profile is determined to be unavailable on the scanner 10-2 (NO), the determination unit 230 advances the process to Step S6-8.

In Step S6-3, the determination unit 230 of the user terminal 20-2 determines whether path information is included in the profile. When the profile includes path information (YES), the determination unit 230 advances the process to Step S6-4. On the other hand, when the profile does not include path information (NO), the determination unit 230 advances the process to Step S6-7.

In Step S6-4, the determination unit 230 of the user terminal 20-2 determines whether an abstract representation is included in the path information of the profile. When an abstract representation is included in the path information (YES), the determination unit 230 sends the path information including the abstract representation to the conversion unit 240, and advances the process to Step S6-5. On the other hand, when the path information does not include an abstract representation (NO), the determination unit 230 advances the process to Step S6-6.

In Step S6-5, the conversion unit 240 of the user terminal 20-2 receives a mapping table from the acquisition unit 220. The conversion unit 240 receives the path information including the abstract representation from the determination unit 230. The conversion unit 240 converts the path information including the abstract representation into path information corresponding to the directory structure of the user terminal 20-2 based on the mapping table. The conversion unit 240 sends the converted path information to the determination unit 230. The determination unit 230 receives the converted path information from the conversion unit 240.

In Step S6-6, the determination unit 230 of the user terminal 20-2 determines whether a file or a folder indicated in the path information of the profile and the converted path information is present in the user terminal 20-2. When all files or folders indicated in the path information are determined to be present in the user terminal 20-2 (YES), the determination unit 230 advances the process to Step S6-7. On the other hand, when any of the files or folders indicated in the path information is determined not to be present in the user terminal 20-2 (NO), the determination unit 230 advances the process to Step S6-8.

In Step S6-7, the determination unit 230 of the user terminal 20-2 determines that the profile is available. The determination unit 230 sends the profile and the determination result indicating that the profile is available to the display unit 250.

In Step S6-8, the determination unit 230 of the user terminal 20-2 determines that the profile is unavailable. The determination unit 230 sends the profile and the determination result indicating that the profile is unavailable to the display unit 250.

### User Interfaces

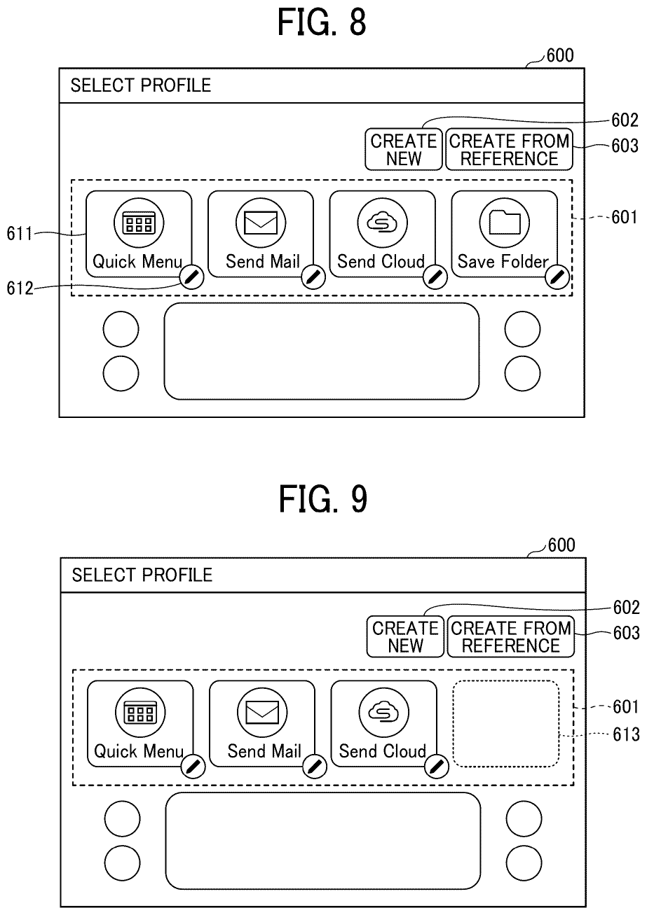

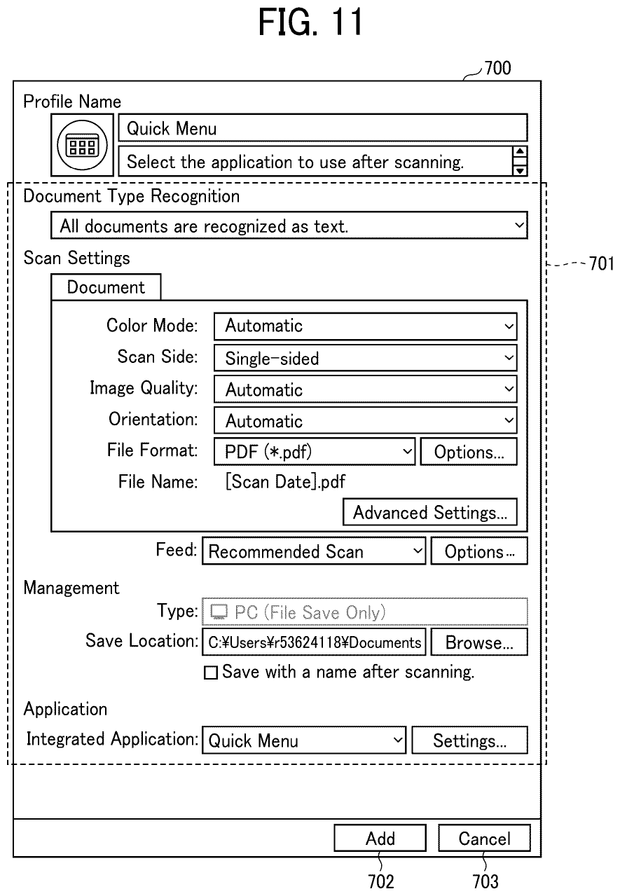

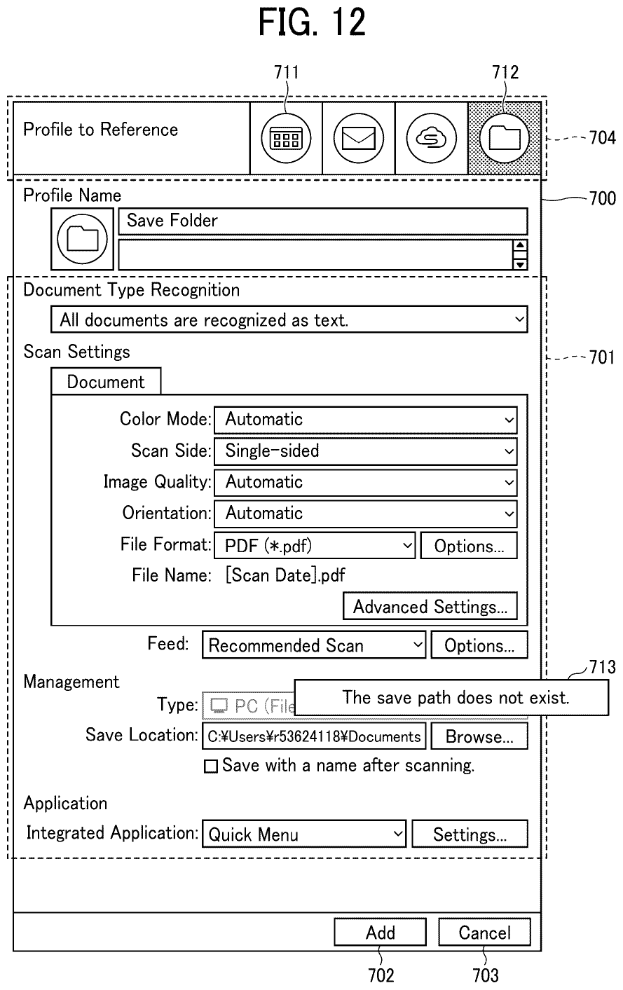

Screens of the scanner software serving as user interfaces of the profile synchronization system 1000 are described below with reference to FIGS. 8 to 12. The screens of the scanner software include a profile selection screen (see FIGS. 8 to 10) and a profile creation screen (see FIGS. 11 and 12).

### Profile Selection Screen

The profile selection screen is a screen to display a list of profiles and receives the selection of a profile to be used or edited. The profile selection screen may receive an operation for creating a profile. The profile selection screen may receive the selection of a profile to be referred to for creating a profile.

FIG. 8 is a diagram illustrating a first example of the profile selection screen. FIG. 8 is an example of the profile selection screen displayed when all profiles are available. As illustrated in FIG. 8, a profile selection screen 600 includes a profiles display section 601, a “Create New” button 602, and a “Create from Reference” button 603.

The profiles display section 601 displays select buttons 611 corresponding to created profiles. The profiles display section 601 displays edit buttons 612 for editing the profiles near the select buttons 611. FIG. 8 illustrates an example of the profiles display section 601 that displays profiles named “Quick Menu,” “Send Mail,” “Send Cloud,” and “Save Folder.”

In response to an operation of pressing the select button 611 by the user U, scanning using the profile starts. In response to an operation of pressing the edit button 612 by the user U, a profile creation screen for editing the corresponding profile opens. In response to an operation of pressing the “Create New” button 602 by the user U, a profile creation screen for creating a new profile opens. In response to an operation of pressing the “Create from Reference” button 603 by the user U, a profile creation screen for creating a profile by referring to an existing profile opens.

FIG. 9 is a diagram illustrating a second example of the profile selection screen. FIG. 9 is an example of the profile selection screen displayed when some profiles are unavailable. The profile selection screen 600 illustrated in FIG. 9 displays available profiles and does not display an unavailable profile. In the profile selection screen 600 illustrated in FIG. 9, an area 613 corresponding to the select button 611 and the edit button 612 that corresponds to the profile named “Save Folder” in FIG. 8 is blank.

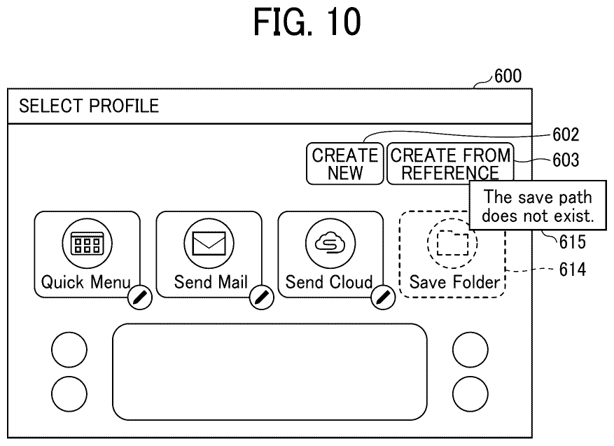

FIG. 10 is a diagram illustrating a third example of the profile selection screen. FIG. 10 is another example of the profile selection screen displayed when some profiles are unavailable. The profile selection screen 600 illustrated in FIG. 10 displays the available profiles in an enabled state and displays the unavailable profile in a disabled state. In the profile selection screen 600 illustrated in FIG. 10, a select button 614 corresponding to the profile named “Save Folder” is displayed in an inoperable state. Further, in the profile selection screen 600 illustrated in FIG. 10, a tooltip 615 indicating the reason for the determination of unavailability of the profile is displayed near the select button 614. The tooltip 615 may be displayed only when a pointer such as a mouse cursor is present near the select button 614.

FIG. 11 is a diagram illustrating a first example of the profile creation screen. FIG. 11 is an example of the profile creation screen for creating a new profile. As illustrated in FIG. 11, a profile creation screen 700 includes a setting items input section 701, an “Add” button 702, and a “Cancel” button 703.

The setting items input section 701 receives an input of a setting item included in a profile. The setting items input section 701 illustrated in FIG. 11 includes setting items related to scanning (scan settings), a setting item for specifying a storage destination of an image file (save location), and a setting item for specifying an application to process an image file (integration application).

In response to an operation of pressing the “Add” button 702 by the user U, an operation for storing a profile including the setting item values input on the profile creation screen 700 is received. In response to an operation of pressing the “Cancel” button 703 by the user U, the setting item values input on the profile creation screen 700 are discarded, and the profile creation screen 700 closes without storing a profile.

FIG. 12 is a diagram illustrating a second example of the profile creation screen. FIG. 12 is an example of a profile creation screen for creating a profile while referring to an existing profile. As illustrated in FIG. 12, the profile creation screen 700 for creating a profile while referring to an existing profile includes a profile selection section 704 in addition to the setting items input section 701, the “Add” button 702, and the “Cancel” button 703.

The profile selection section 704 displays a select button 711 corresponding to a created profile. Even when a profile is determined to be unavailable, the profile selection section 704 displays the select button 712 corresponding to the profile. In the profile creation screen 700 illustrated in FIG. 12, a select button 712 corresponding to a profile named “Save Folder” is displayed in an operable state. Further, in the profile creation screen 700 illustrated in FIG. 12, a tooltip 713 indicating the reason for the determination of unavailability of the profile is displayed. The tooltip 713 may be displayed only when a pointer such as a mouse cursor is present near a setting item that is the reason for the determination of unavailability of the profile.

### Modification

In the above-described embodiment, the scanner software is installed on the user terminal 20, and a profile created in the user terminal 20-1 is synchronized with the user terminal 20-2. In the following description of a modification, the scanner 10 has a function of creating a profile and a profile created by the scanner 10-1 is synchronized with the scanner 10-2. The profile synchronization system 1000 according to the present modification is described below, focusing on the differences from the above-described embodiment.

In the present modification, the profile synchronization system 1000 includes multiple scanners 10 and the synchronization server 30. That is, in the present modification, the profile synchronization system 1000 may not include the user terminal 20. The scanner 10 and the synchronization server 30 are connected to each other via the communication network N1 for communication.

The scanner 10 includes a controller built therein. The controller is an example of an information processing apparatus that controls the operation of the scanner 10. The controller may be implemented by the computer 500 having the hardware configuration illustrated in FIG. 2. The controller has a functional configuration substantially the same as or similar to that of the user terminal 20 illustrated in FIG. 3. In other words, in the present modification, the operation of the scanner 10 is implemented by the controller built in the scanner 10.

The user U creates a profile by operating a screen displayed on a display of the scanner 10-1. In the present modification, the profile may include at least settings related to scanning. The scanner 10-1 transmits a profile addition request including a profile created by the user U to the synchronization server 30. The synchronization server 30 stores the profile received from the scanner 10-1 in the storage unit 300.

The scanner 10-2 transmits a profile acquisition request to the synchronization server 30 at any desired timing. The scanner 10-2 may transmit the profile acquisition request in response to an operation performed by the user U. The scanner 10-2 may transmit the profile acquisition request at predetermined time intervals. When the synchronization server 30 receives the profile acquisition request, the synchronization server 30 transmits the profile read from the storage unit 300 to the scanner 10-2.

The scanner 10-2 determines whether the profile received from the synchronization server 30 is available. Specifically, the scanner 10-2 determines whether the settings related to scanning included in the profile are supported by the scanner 10-2. When the scanner 10-2 does not support the settings related to scanning, the scanner 10-2 determines that the profile is unavailable. The scanner 10-2 may adjust the settings related to scanning to be available on the scanner 10-2.

The scanner 10-2 displays the profile on a display in a state according to the determination result of whether the profile is available. For example, the scanner 10-2 may display the profile determined to be available and may hide the profile determined to be unavailable. For example, the scanner 10-2 may display a profile determined to be available in an enabled state and display a profile determined to be unavailable in a disabled state.

The user terminal 20 according to the present embodiment acquires a profile related to the use of an electronic apparatus, determines whether the profile is available, and displays the profile according to the determination result. According to an aspect of the present embodiment, the availability of the displayed profile can be easily recognized by the user, enhancing the usability of the profile.

The user terminal 20 may determine that the profile is available when the environment in which the profile was created is the same as the environment of the user terminal 20. According to an aspect of the present embodiment, since a profile that was created in the same environment is likely to be available, whether the profile is available can be easily determined.

When a profile is unavailable on the electronic apparatus, the user terminal 20 may determine that the profile is unavailable. According to an aspect of the present embodiment, a profile including a setting that is not supported by an electronic apparatus can be determined to be unavailable.

The user terminal 20 may determine that a profile is unavailable when the profile includes path information indicating a file or a folder that is absent in the user terminal 20. According to an aspect of the present embodiment, a profile including path information indicating a file or a folder that is absent in the user terminal 20 can be determined to be unavailable.

When a profile includes path information including a predetermined abstract representation, the user terminal 20 may convert the path information into path information corresponding to the directory structure of the user terminal 20, and when the converted path information indicates a file or a folder that is absent in the user terminal 20, the user terminal 20 may determine that the profile is unavailable. According to an aspect of the present embodiment, since the path information can be configured using an abstract representation that is independent of the directory structure, whether the profile is available can be determined based on the directory structure of the user terminal 20.

The user terminal 20 may display a profile determined to be available and hide a profile determined to be unavailable. The user terminal 20 may display a profile determined to be available in an enabled state and display the profile determined to be unavailable in a disabled state. According to an aspect of the present embodiment, whether a profile is available can be easily determined.

The user terminal 20 may display information indicating the reason for the determination of unavailability of a profile in association with the profile determined to be unavailable. According to an aspect of the present embodiment, the reason for the determination of unavailability of a profile can be easily specified, and the profile determined to be unavailable can be easily adjusted.

The electronic apparatus may include the scanner 10. The profile may include path information indicating a location of a folder that stores an image read by the scanner 10. The profile may include path information indicating a location of an execution file of an application that processes an image read by the scanner 10. According to an aspect of the present embodiment, the usability of the profiles for using the scanner 10 is enhanced.

In the related art, there is room to enhance the usability of setting information. For example, when the settings file is not restored for an application, the settings file needs to be manually created for the application to work.

According to one aspect of the present disclosure, the usability of the setting information is enhanced.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or digital versatile disc (DVD), and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to:
acquire setting information related to use of an electronic apparatus;
determine whether the setting information is available; and
display, on a display, the setting information according to a determination result indicating whether the setting information is available.

2. The information processing apparatus of claim 1, wherein
the circuitry determines that the setting information is available when an environment in which the setting information was created is identical to an environment of the information processing apparatus.

3. The information processing apparatus of claim 1, wherein
the circuitry determines that the setting information is unavailable when the setting information is unavailable on the electronic apparatus.

4. The information processing apparatus of claim 1, wherein
the setting information includes path information indicating a file or a folder, and
the circuitry determines that the setting information is unavailable when the file or the folder indicated by the path information is absent in the information processing apparatus.

5. The information processing apparatus of claim 4, wherein,
when the path information includes a predetermined abstract representation, the circuitry is further configured to:
convert the path information to obtain converted path information corresponding to a directory structure of the information processing apparatus; and
determine that the setting information is unavailable when the converted path information indicates a file or a folder that is absent in the information processing apparatus.

6. The information processing apparatus of claim 1, wherein
the circuitry is configured to:
display the setting information when the determination result indicates that the setting information is available; and
hide the setting information when the determination result indicates that the setting information is unavailable.

7. The information processing apparatus of claim 1, wherein
the circuitry is configured to:
display the setting information in an enabled state when the determination result indicates that the setting information is available; and
display the setting information in a disabled state when the determination result indicates that the setting information is unavailable.

8. The information processing apparatus of claim 1, wherein,
when the determination result indicates that the setting information is unavailable, the circuitry is configured to display a reason for the determination result in association with the setting information.

9. The information processing apparatus of claim 1, wherein
the electronic apparatus includes an image reading apparatus.

10. The information processing apparatus of claim 9, wherein
the setting information includes path information indicating a location of a folder that stores an image read by the image reading apparatus.

11. The information processing apparatus of claim 9, wherein
the setting information includes path information indicating a location of an execution file for an application that processes an image read by the image reading apparatus.

12. An information processing method performed by an information processing apparatus, comprising:
acquiring setting information related to use of an electronic apparatus;
determining whether the setting information is available; and
displaying, on a display, the setting information according to a determination result of the determining.

13. A computer-readable, non-transitory medium storing a computer program, wherein the computer program causes an information processing apparatus including circuitry to execute a process, the process comprising:
acquiring setting information related to use of an electronic apparatus;
determining whether the setting information is available; and
displaying, on a display, the setting information according to a determination result of the determining.
